(19) United States
(12) Patent Application Publication
(10) Pub. No.: US 2022/0010613 A1
(43) Pub. Date: Jan. 13, 2022

(54) EASILY ASSEMBLED PANEL FOR A WINDOW

(71) Applicant: HSIAO-WEN HSIEH, Taichung (TW)

(72) Inventor: HSIAO-WEN HSIEH, Taichung (TW)

(21) Appl. No.: 16/924,187

(22) Filed: Jul. 9, 2020

(51) Int. Cl. E06B 7/09; E06B 9/386; E06B 9/264

(52) U.S. Cl. CPC E06B 7/09; E06B 2009/3222; E06B 9/264; E06B 9/386

(57) ABSTRACT

A panel includes a panel frame for pivotally supporting louvers. The panel frame includes two vertical planks, two transverse planks and four connectors. Each of the vertical planks includes two ends. Each of the transverse planks includes two ends. Each of the tracks is formed on a corresponding one of the vertical planks. Each of the connectors includes a vertical strip, a horizontal strip, two flank strips and two crooks. The vertical strip is connected to a corresponding one of the ends of a corresponding one of the transverse planks in a detachable manner. The horizontal strip is connected to a corresponding one of the ends of a corresponding one of the vertical planks in a detachable manner. The flank strips extend on two sides of the vertical strip. The crooks extend toward each other from the flank strips, and render the track smoothly movable toward horizontal strip between two flank strips.

### BACKGROUND OF INVENTION

### 1. Field of Invention

The present invention relates to a panel for a window and, more particularly, to a panel that is easily assembled.

### 2. Related Prior Art

Referring to FIG. 8, a conventional panel 80 includes a panel frame 81, louvers 90, two strips 93 and blocks 94. The panel frame 81 includes two vertical planks 82 and two transverse planks 83. Each vertical plank 82 includes two panels (not numbered) separated from each other by a groove 84. Each panel includes a ridge 88. The ridges 88 extend toward each other. There is a slit 85 between the ridges 88. Each transverse plank 83 includes two enlarged portions 86 and two reduced portions 87. Each enlarged portion 86 is formed at a corresponding end of the corresponding transverse plank 83. Each reduced portion 87 is formed next to the corresponding enlarged portion 86 of the corresponding transverse plank 83.

Each louver 90 includes two ends. A detent 91 is biased by a spring 92 inserted in each end of each louver 90. Each strip 93 includes apertures. Each block 94 includes a bore. The blocks 94 are sorted into two groups.

Each detent 91 extends into a block 94 through an aperture made in a strip 93.

The vertical planks 82 are located parallel to each. The louvers 90 are located between the vertical planks 82. Each strip 93 and a corresponding group of blocks 94 are inserted in the groove 84 of a corresponding vertical plank 82. Each detent 91 is moved in and along the slit 85 between the ridges 88 of a corresponding vertical plank 82.

Each enlarged portion 86 of each transverse plank 83 is inserted in the groove 84 of a corresponding vertical plank 82 through a corresponding open end. Now, each reduced portion 87 of each transverse plank 83 is inserted in the slit 85 between the ridges 88 of a corresponding vertical plank 82. Thus, the vertical planks 82 are connected to the transverse planks 83 so that the panel frame 81 is assembled.

Each end of each strip 93 is abutted against a corresponding transverse plank 83. Thus, the length of each strip 93 determines the distance between the transverse planks 83.

As described above, the detents 91 and the compression springs 92 are connected to the louvers 90 before the strips 93 and the blocks 94 are inserted in the vertical planks 82. Then, the transverse planks 83 are connected to the vertical planks 82. The assembling of the panel 80 takes a lot of time and hence costs a lot of money, and so is maintenance of the panel 80.

The present invention is therefore intended to obviate or at least alleviate the problems encountered in prior art.

### SUMMARY OF INVENTION

It is the primary objective of the present invention to provide a window with a panel that is easily assembled.

To achieve the foregoing objective, the panel includes a panel frame for pivotally supporting louvers. The panel frame includes two vertical planks, two transverse planks and four connectors. Each of the vertical planks includes two ends. Each of the transverse planks includes two ends. Each of the tracks is formed on a corresponding one of the vertical planks. Each of the connectors includes a vertical strip, a horizontal strip, two flank strips and two crooks. The vertical strip is connected to a corresponding one of the ends of a corresponding one of the transverse planks in a detachable manner. The horizontal strip is connected to a corresponding one of the ends of a corresponding one of the vertical planks in a detachable manner. The flank strips extend on two sides of the vertical strip. The crooks extend toward each other from the flank strips, and render the track smoothly movable toward horizontal strip between two flank strips.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a panel according to the preferred embodiment of the present invention;

FIG. 2 is a partial and exploded view of the panel shown in FIG. 1;

FIG. 3 is a perspective view of a connector used in the panel shown in FIG. 1;

FIG. 4 is a partial and cross-sectional view of the panel of FIG. 1;

FIG. 5 is another partial and cross-sectional view shown in the panel of FIG. 1;

FIG. 6 is a partial and cross-sectional view of a panel according to the second embodiment of the present invention;

FIG. 7 is another partial and cross-sectional view of the panel shown in FIG. 6; and

FIG. 8 is an exploded view of a conventional panel.

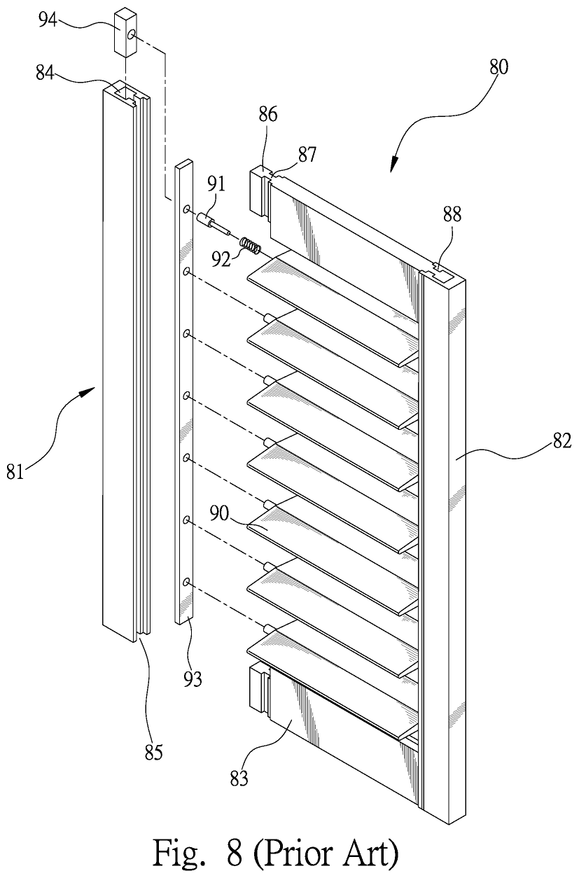

### DETAILED DESCRIPTION OF EMBODIMENTS

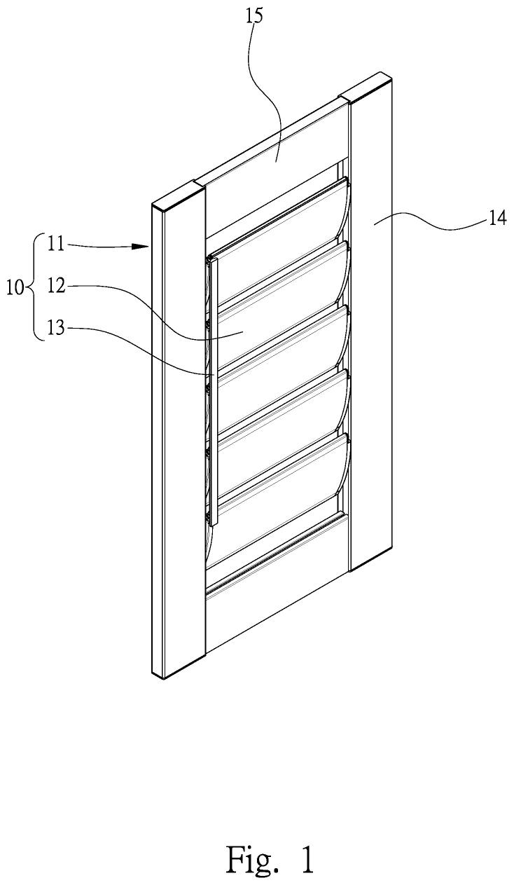

Referring to FIG. 1, a panel 10 includes a panel frame 11, several louvers 12 and a linking element 13 according to a first embodiment of the present invention. The panel frame 11 includes two vertical planks 14 extending parallel to each other and two transverse planks 15 extending parallel to each other. The louvers 12 are located between and pivotally connected to the vertical planks 14. The linking element 13 is connected to all the louvers 12 so that the linking element 13 is operable to pivot all the louvers 12. However, the pivotal connection of the louvers 12 to the vertical planks 14 and the maneuver of the linking element 13 to pivot the louvers 12 will not be described in detail for not being the spirit of the present invention.

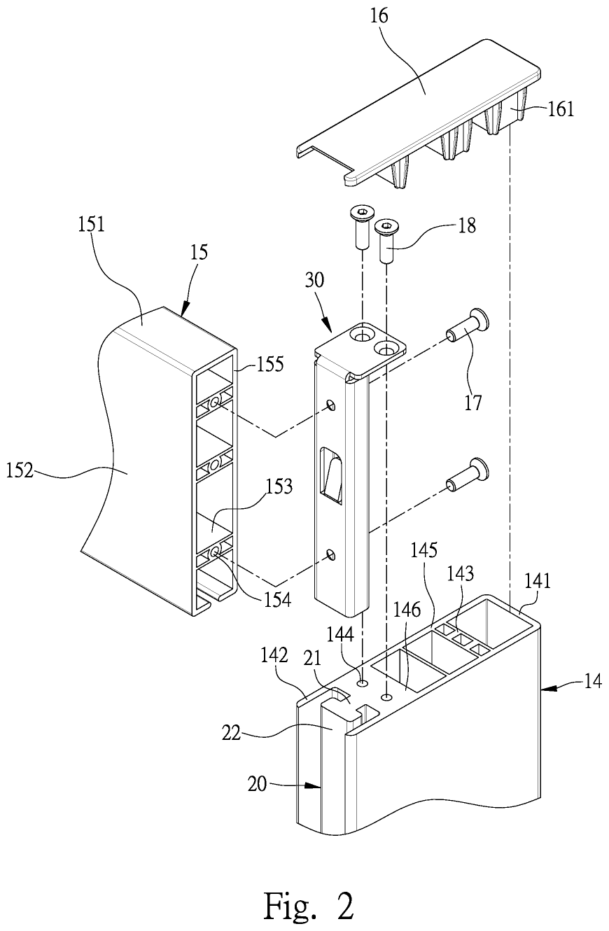

Referring to FIG. 2, the panel frame 11 further includes a connector 30 at each of four corners of the panel frame 11. That is, the panel frame 11 includes four connectors 30 although only one of them is shown. The connectors 30 are structurally identical to one another but used in different positions. For briefness and clarity, the following description will be given to only one of the connectors 30, only one of the vertical planks 14 and only one of the transverse planks 15. The connector 30 connects the vertical plank 14 to the transverse plank 15.

The vertical plank 14 includes an external strip 141, two panels 142, a rib 143 and an internal strip 146. The panels 142 extend from the external strip 141. The rib 143 and the internal strip 146 are formed between the panels 142. The rib 143 interconnects the panels 142 to enhance the strength of the vertical plank 14. The internal strip 146 includes two bores 144 made in each of two ends. The external strip 141, the panels 142, the rib 143 and the internal strip 146 extend between two ends 145 of the vertical plank 14.

A track 20 is formed on the vertical plank 14. The track 20 is T-shaped in a top view of the vertical plank 14. The track 20 is located between the panels 142 of the vertical plank 14. The track 20 includes a stem 21 and a flange 22. The stem 21 extends on and along the internal strip 146 of the vertical plank 14. The flange 22 extends on and along the stem 21 so that the flange 22 extends perpendicular to the stem 21. The flange 22 includes two portions on two opposite sides of the stem 21.

The plank 15 includes an external strip 151, two panels 152 and several ribs 153. The panels 152 extend from the external strip 151. The ribs 153 interconnect the panels 152 to enhance the strength of the transverse plank 15. Each rib 153 includes a bore 154 at each of two ends. The external strip 151, the panels 152 and the ribs 153 extend between two ends 155 of the transverse plank 15.

The panel frame 11 further includes four plates 16 for covering the connectors 30. However, only one of the plates 16 will be described for briefness and clarity. The plate 16 includes inserts 161 extending from a side. Each of the inserts 161 is a tapered element.

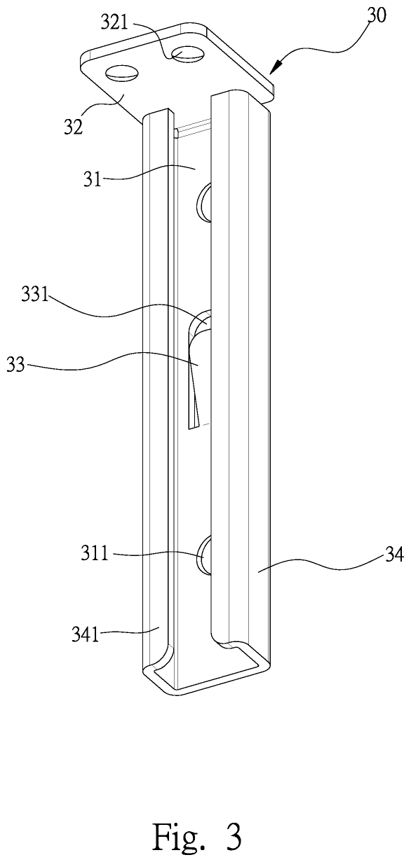

Referring to FIG. 3, the connector 30 includes a vertical strip 31, a horizontal strip 32 and two flank strips 34. The horizontal strip 32 is formed at an end of the vertical strip 31. The flank strips 34 extend along two vertical edges of the vertical strip 31. Each of the flank strips 34 is formed with a crook 341. The crooks 341 extend toward each other from the flank strips 34. The flank strips 34 (including the crooks 341) and the horizontal strip 32 are located on a same side of the vertical strip 31 so that the flank strips 34 (including the crooks 341) are located beneath or on the horizontal strip 32.

The vertical strip 31 of the connector 30 includes a slot 331 between two orifices 311. The slot 331 is made by punching the vertical strip 31 with an inverted U-shaped slit and bending a portion of the vertical strip 31 defined by the inverted U-shaped slit. The bent portion of the vertical strip 31 is used as a leaf spring 33.

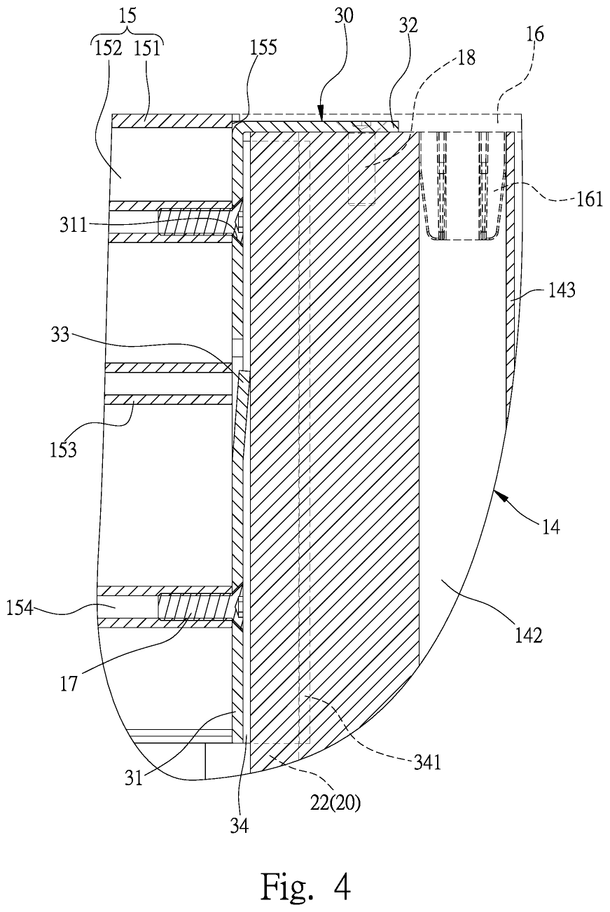

Referring to FIG. 4, an exemplary one of the corners of the panel frame 11 is shown. Fasteners 17 in the form of screws are inserted in the bores 154 of the ribs 153 via the orifices 311 of the vertical strip 31, thereby connecting the vertical strip 31 to the end 155 of the transverse plank 15 while allowing detachment of the vertical strip 31 from the end 155 of the transverse plank 15. Fasteners 18 in the form of screws are inserted in the bores 144 of the rib 143 via apertures 321 made in the horizontal strip 32 to connect the horizontal strip 32 to the rib 143 while allowing detachment of the horizontal strip 32 from the end 145 of the vertical plank 14. The inserts 161 are inserted in recesses (not numbered) made in the end 145 of the vertical plank 14 so that the plate 16 covers the end 145 of the vertical plank 14 and the horizontal strip 32 of the connector 30.

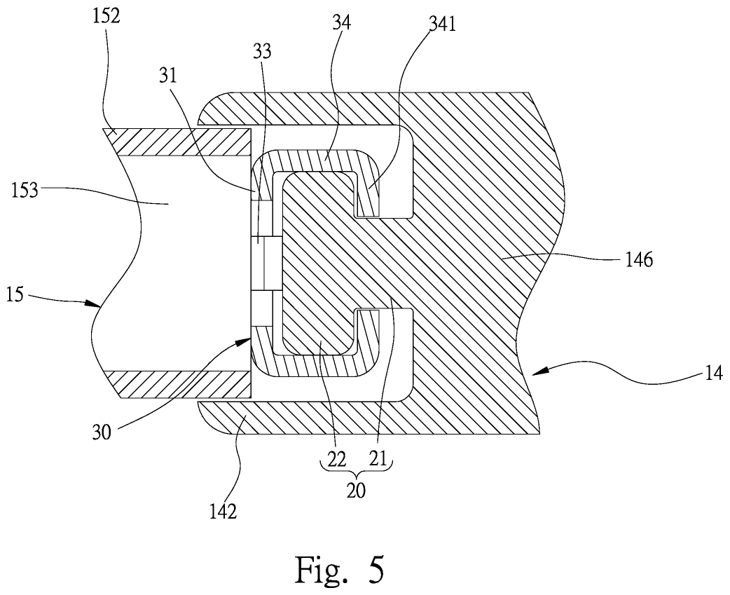

Referring to FIG. 5, the panels 152 of the transverse plank 15 are located between the panels 142 of the vertical plank 14. The stem 21 is inserted in a gap between the crooks 341. The crooks 341 are in contact with the portions of the flange 22 and the vertical strip 31, respectively. The crooks 341 retain the track 20 between the flank strips 34, thereby ensuring smooth movement of the track 20 to the horizontal strip 32 in a longitudinal direction of the vertical strip 31. The leaf spring 33 presses a side of the flange 22 to press another side of the flange 22 against the crooks 341. The stem 21 does not interfere with the movement of the flange 22 between and relative to the flank strips 34. The leaf spring 33 keeps the portions of the flange 22 against the crooks 341 when the stem 21 is located between crooks 341. The flank strips 34 are located between the panels 142 when the horizontal strip 32 is connected to the vertical plank 14.

As described above, the panel frame 11 is easily assembled for using each connector 30 to connect the corresponding vertical plank 14 to the corresponding transverse plank 15 at the corresponding corner of the panel 10. Moreover, the louvers 12 are easily connected to the panel frame 11 after the panel frame 11 is assembled. Hence, the assembling and dismantling of the panel 10 takes only a short period of time and costs only a small amount of money.

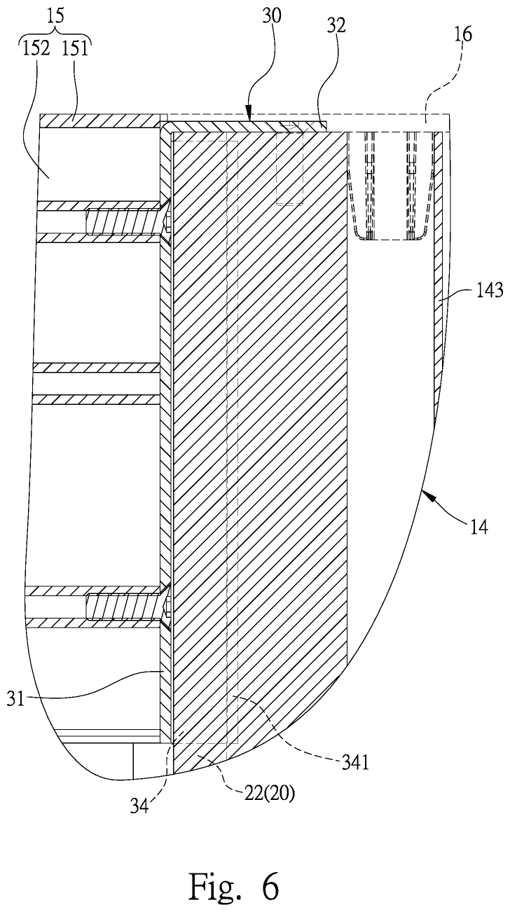

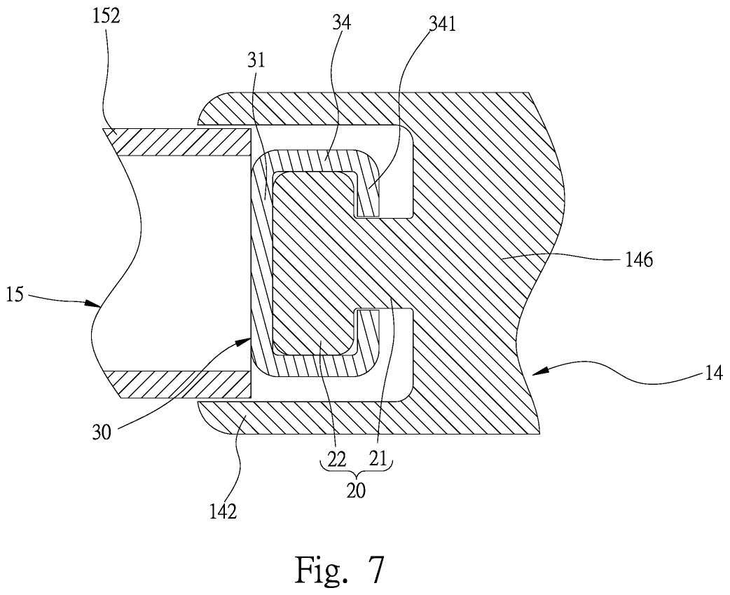

Referring to FIGS. 6 and 7, there is shown a panel frame 11 according to a second embodiment of the present invention. The second embodiment is like the first embodiment except that each connector 30 does not include any leaf spring or slot. The stem 21 is still movable in and along the gap between the crooks 341, and the flange 22 is movable in the longitudinal direction of the vertical strip 31 when the vertical plank 14 is moved relative to the transverse plank 15 as the panels 152 are located between the panels 142.

The present invention has been described via the illustration of the embodiments. Those skilled in the art can derive variations from the embodiments without departing from the scope of the present invention. Therefore, the embodiments shall not limit the scope of the present invention defined in the claims.

1. A panel comprising louvers and a panel frame for pivotally supporting the louvers, wherein the panel frame comprises:
two vertical planks each of which comprises two ends;
two transverse planks each of which comprises two ends;
two tracks each of which is formed on a side of a corresponding one of the vertical planks;
four connectors each of which comprises:
a vertical strip connected to a corresponding one of the ends of a corresponding one of the transverse planks in a detachable manner;
a horizontal strip connected to a corresponding one of the ends of a corresponding one of the vertical planks in a detachable manner; and
two flank strips each of which extends on and along a corresponding one of the vertical strips, wherein the crooks render the track smoothly movable toward horizontal strip between two flank strips.

2. The panel according to claim 1, wherein the crooks and the horizontal strip are located on a same side of the vertical strip.

3. The panel according to claim 1, wherein the vertical strip comprises a leaf spring for biasing the track against the crooks.

4. The panel according to claim 3, wherein the leaf spring is made by making a slot in the vertical strip.

5. The panel according to claim 3, wherein the leaf spring extends toward the horizontal strip from the vertical strip.

6. The panel according to claim 1, wherein each of the vertical planks comprises two panels and an external strip formed between the panels, wherein the flank strips of the connector and portions of the transverse plank are located between the panels of the vertical plank.

7. The panel according to claim 6, wherein each of the vertical planks comprises a rib formed between the panels to enhance strength thereof, wherein the rib is connected to the horizontal strip.

8. The panel according to claim 6, further comprising four plates each of which comprises at least one insert inserted in an end of a corresponding one of the vertical planks to cover the corresponding end of the corresponding vertical plank to cover the horizontal strip of the corresponding connector.

9. The panel according to claim 6, wherein the horizontal strip of each of the connectors locates the corresponding transverse plank in a correct position to facilitate the connection of the corresponding one of the transverse planks to the corresponding one of the vertical planks.

10. The panel according to claim 1, wherein each of the vertical planks comprises two panels, an external strip formed between the panels, and an internal strip formed between the panels, wherein the track comprises a stem extending on and along the internal strip and a flange extending on and along the stem, wherein the stem is inserted in a gap between the crooks so that the crooks render the flange smoothly movable in and along a gap between the flank strips.
